(19) United States
(12) Patent Application Publication
(10) Pub. No.: US 2011/0017931 A1
(43) Pub. Date: Jan. 27, 2011

(54) BALL VALVE

(76) Inventor: Chih-Hsin Lee, Hsin Chuang City (TW)

Correspondence Address: LEONG C. LEI, PMB # 1008, 1839 YGNACIO VALLEY ROAD, WALNUT CREEK, CA, 94598, US

(21) Appl. No.: 12/508,579

(22) Filed: Jul. 24, 2009

(51) Int. Cl. F16K 15/04

(52) U.S. Cl. 251/315.05; 251/315.1

(57) ABSTRACT

The present invention provides a ball valve, comprising a valve base, a ball element, a valve shaft and a locking element. The valve base has a containing space opening inside for containing the ball element, and having a lining layer on its inner wall. The locking element is threaded onto one side of the valve base, and correspondingly having a lining layer on its inner wall to separate water and metal materials (mainly refers to lead), in order to prevent contamination from metal material to water.

### BACKGROUND OF THE INVENTION

1. Field of the Invention

The present invention relates to a technology for manipulating water-flow in the pipe, and more particularly to an intoxication-free inner lining of the ball valve structure.

2. Related Art

Our everyday drinking water is usually transported by water pipe, therefore the material of water pipe has to conform the national standards or regulations for safety and health. Ordinary water pipe also provides plurality of switches for controlling the water flow, so-called “valve”, and controlling the inter-pipe water flow in order to proceed some indispensable maintenances and replacements. Conventionally, an ordinary ball valve provides a rotational ball element in a valve base; an aperture is opened through the center of the ball element to form a path with the flow tunnel of the valve base. With this mechanism, people can manipulate water flows on/off with the shielding effect caused by the control of ball element's rotation.

However in the prior art, the valve base is made by forging or sand casting with bronze zinc alloy (59% of red bronze, zinc and lead for the rest composition. And lead takes more than 1% of total.), so it can be cut or manufactured easier, and the ball element is made in the same way. The water contacts with alloy contained with lead when passing through the valve base, causing the lead being dissolved in drinking water greatly. After drinking the water described above, lead ions that the water contained react with carbon dioxide in human bodies and are transferred to lead carbonates. Moreover, it further generates replacement reaction with calcium in one's frame and will cause chronic diseases. Furthermore, lead holds a strong affinity to neural system, so that lead does stronger toxicity to children in development phase than grownups during. For this reason, a national standard or regulation suggests that the lead's quantity ratio in the drinking water shall be lower than 0.25% after passing through the ball valve(s) for ensuring the health of nationals.

### SUMMARY OF THE INVENTION

In view of the defects of the conventional art, the present invention is directed to a ball valve which lowers the lead content in water after passing through water pipe.

In order to achieve the above object, the present invention contains a valve base, a ball element, a valve shaft, a handle and a locking element. Wherein, a flow tunnel goes through the valve base interiorly, and a containing space is formed in the flow tunnel. The inner wall of the containing space and part of the flow tunnel is provided with a first inner lining, and an aperture is perpendicularly disposed above the containing space. A penetrative aperture is centrally provided in the ball element and a valve shaft aperture is provided on the top of the ball element, the valve shaft pierces through the penetrative aperture. One end of the handle is connected with one end of the valve shaft jointly. A second inner lining is provided on the inner wall of the locking element, and a second thread portion is provided on the outer wall of one end for threading into a first thread portion provided in the valve base near the containing space.

Compare to the conventional art, the present invention provides numerous inner linings, so that when the water flows among the ball element and the inner linings, the present invention prevents the water from being contacted with the metal material of valve base (mainly lead). In addition, the ball element in the present invention is made of stainless steel, so as to avoid the contamination of metal material and ensure the safety of drinking water.

### BRIEF DESCRIPTION OF THE DRAWINGS

The present invention will become more fully understood from the detailed description given below and the figures for illustration only. The figures are not limited to the present invention, wherein:

FIG. 1 is a solid exploded schematic view of preferred embodiment of present invention;

FIG. 2 is a combinative schematic view of preferred embodiment of present invention;

FIG. 3 is a solid combinative schematic view of preferred embodiment of present invention;

FIG. 4 is a first schematic view of using preferred embodiment of present invention; and

FIG. 5 is a second schematic exploded view of preferred embodiment of present invention;

### DETAILED DESCRIPTION OF THE INVENTION

The implementation of the present invention is described with specific detailed embodiments as following, and those of ordinary skill in the art may easily understand other advantages and efficacies of the present invention from the content of the specification.

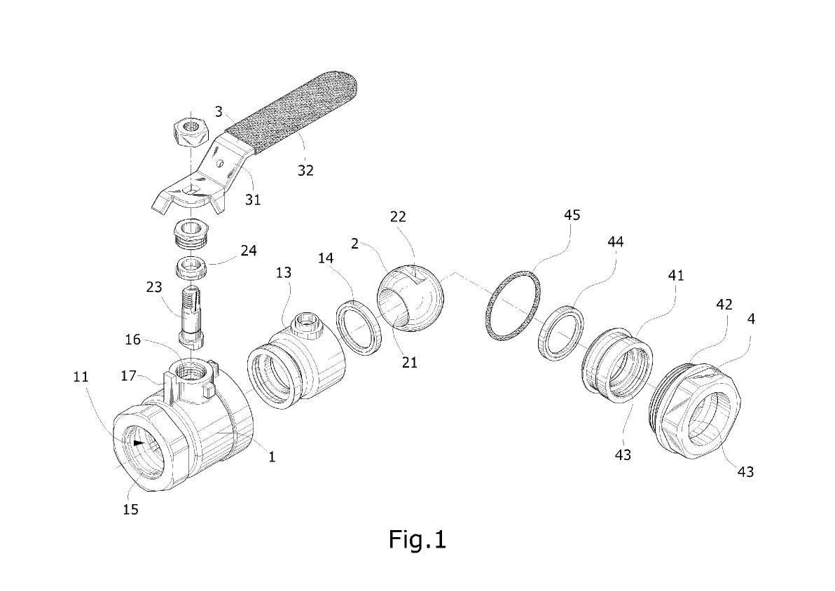

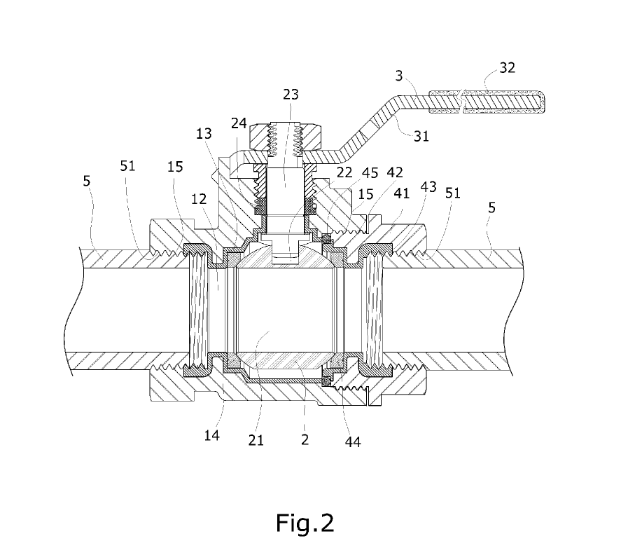

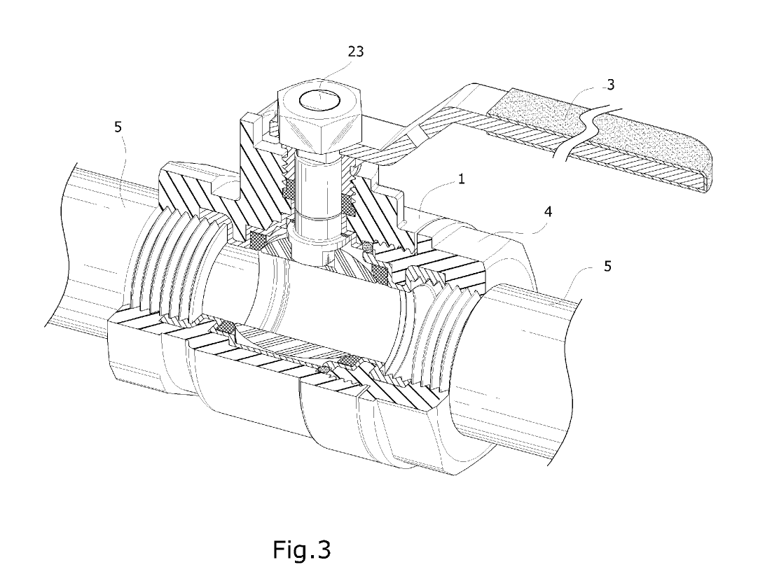

FIGS. 1-3 are schematic views of preferred embodiment of present invention, mainly comprising: a valve 1 which is in a tube shape, a flow tunnel 11 running centrally through the interior of the valve base 1, a containing space 12 formed on one side of the flow tunnel 11. The inner wall of the containing space 12 and part of the flow tunnel 11 is provided with a first inner lining 13. The first inner lining 13 is made of toxicity-free plastic material such as HDPE (High Density Polyethylene), POM (Polyoxymethylene) and LLDPE . . . etc. A first anti-leaking ring 14 is set on an aperture of one end of the flow tunnel 11. An inclined plane is provided on one side of the first anti-leaking ring 14. A first thread portion 15 is provided on each end of the flow tunnel 11, and is partially formed on the first inner lining 13. This combination keeps isolation from drinking water to contact with metal material when a pipe 5 is threaded. Besides, an aperture 16 is perpendicularly disposed above the containing space 12, and at least one stopper portion 17 is provided on the wall of the aperture 16.

In this embodiment, a ball element 2 is provided in the containing space 12 of the valve base 1 movably, and a penetrative aperture 21 is centrally provided therein. A valve shaft aperture 22 is provided on the top of the ball element 2. As shown in FIGs, the valve shaft aperture 22 is a strip-shaped aperture, and a valve shaft 23 is disposed within the valve shaft aperture 22. One end of the valve shaft 23 pierces out of the aperture 16 of the valve base 1, and the valve shaft 23 connects with the ball element 2. Further, a second anti-leaking ring 24 is disposed between the valve shaft 23 and the aperture 16.

In this embodiment, one end of a handle 3 is connected with one end of the valve shaft 23, so as to make the ball element 2 and the handle 3 move simultaneously. A curvature portion 31 is provided in the center of the handle 3. A protective suit 32 is covered on the surface of the curvature portion 31. The stopper portion 17 on the outer wall of the aperture 16 is used to restrict the movement of handle 3 for meeting the purpose of manipulating the rotation angle of the ball element 2.

A locking element 4 is provided in this embodiment, and a second inner lining 41 is provided on its inner wall. The second inner lining 41 is similarly made of toxicity-free plastic material. A second thread portion 42 is provided on the outer wall of one end of the locking element 4, for threading into the first thread portion 15 provided on the valve base 1 near the containing space 12. A third thread portion 43 is provided on the inner wall of the other side of the locking element 4, and partially provided on the second inner lining 41. A third anti-leaking ring 44 is disposed on the inner wall of the licking element 4. An inclined surface is provided on one side of the third anti-leaking ring 44. When the present invention is assembled, the first anti-leaking ring 14 of the valve base 1 and the third anti-leaking ring 44 of the locking element 4 both attach to the surface of the ball element 2 firmly, so as to prevent the water flow from being leaked out. Furthermore, a fourth anti-leaking ring 45 is disposed between the valve base 1 and the locking element 4, so as to fill the gap where the locking element 4 is threaded into the valve base 1, and to prevent the water flow from being leaked out.

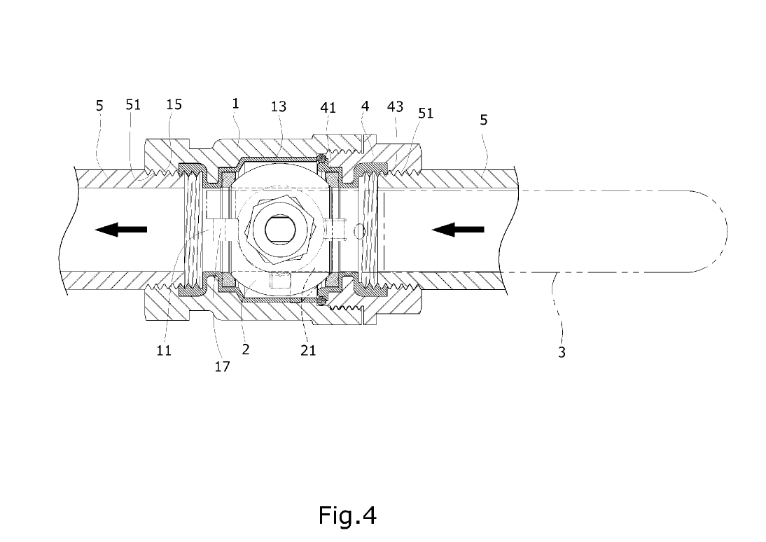

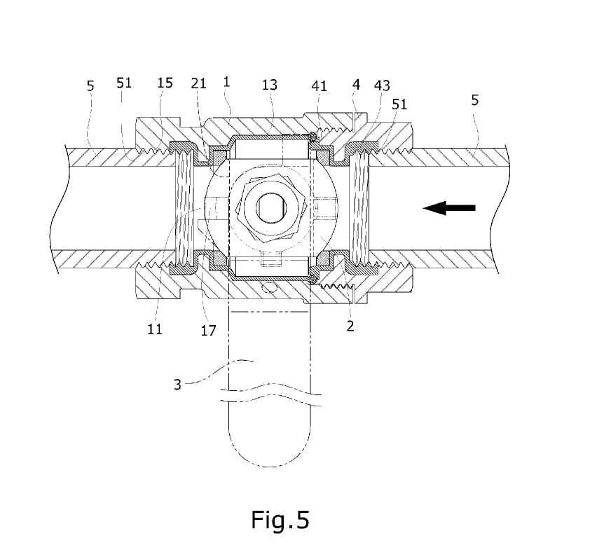

FIG. 4-5 shows the fabrication of present invention, in this embodiment, a fourth thread portion 51 is provided on the outer wall of one end of the pipe 5 in order to assemble the present invention among two pipes 5. Both ends of the pipe 5 are threaded into the first thread portion 15 of the valve base 1 and the second thread portion 43 of the locking element 4 respectively. The first inner lining 13 and the second inner lining 41 are provided in the valve base 1 and the locking element 4 respectively. When a user wants to switch the water flow on/off, revolve the handle 3 to correspondingly revolve the ball element 2, so as to adjust the included angle of the penetrative aperture 21 and the flow tunnel 11. Water flows when the included angle is less than 90 degree. Contrarily, when the included angle equals to 90 degree where the handle 3 is stopped by the stopper portion 17, the penetrative aperture 21 is blocked by the valve base 1, and water flow stops. And more, when the drinking water flows through the valve base 1, the drinking water merely flow through the penetrative aperture 21, the first inner lining 13 and the second inner lining 41 of the ball element 2 made of stainless steel without contacting with the metal material constructing the valve base 1. With those lead-free elements, the present provides an intoxication-free mechanism.

To sum up, as mentioned above and shown in FIG. 1-5, the present invention separates water from metal material to prevent water from being contaminated during passing through the ball valve 2, so as to lower the lead content in drinking water and ensure the safety of drinking water.

The above embodiments are merely intended to illustrate the principles and efficacies of the present invention, but not to limit the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ball valve, comprising:
a valve base, having a flow tunnel going through inside, a containing space being formed in the flow tunnel, and the inner wall of the containing space and part of the flow tunnel being provided with a first inner lining, and an aperture being perpendicularly disposed above the containing space;
a ball element, a penetrative aperture being centrally provided thereto and a valve shaft aperture being provided on the top of the ball element, and a valve shaft piercing through the penetrative aperture;
a handle, having an end connecting with one end of the valve shaft; and
a locking element, a second inner lining being provided on its inner wall, and a second thread portion being provided on the outer wall of one end for threading into a first thread portion provided in the valve base near the containing space.

2. The ball valve according to claim 1, wherein the first and the second inner lining are plastic inner linings.

3. The ball valve according to claim 1, wherein the first and the second inner lining are HDPE (High Density Polyethylene) inner linings.

4. The ball valve according to claim 1, wherein the first and the second inner lining are POM (Polyoxymethylene) inner linings.

5. The ball valve according to claim 1, wherein the first and the second inner lining are LLDPE (Linear Low Density Polyethylene) inner linings.

6. The ball valve according to claim 1, further comprising a first anti-leak ring placed in the containing space opposite to the flow tunnel and a second anti-leak ring placed on the inner wall of the locking element, both rings being firmly attached to the surface of the ball element.

7. The ball valve according to claim 1, further comprising a third anti-leak ring provided inside the aperture.

8. The ball valve according to claim 1, further comprising a stopper portion provided on the outer wall of the aperture for blocking the handle.

9. The ball valve according to claim 1, further comprising a fourth anti-leak ring disposed between the valve base and the locking element.

10. The ball valve according to claim 1, further comprising a curvature portion in the middle of the handle, and a protective sleeve provided along the curvature portion.
